(19) United States
(12) Patent Application Publication
(10) Pub. No.: US 2009/0285390 A1
(43) Pub. Date: Nov. 19, 2009

(54) INTEGRATED CIRCUIT WITH SECURED SOFTWARE IMAGE AND METHOD THEREFOR

(75) Inventors: Stefan Thomas Scherer, Ottawa (CA); Denis Foley, Shrewsbury, MA (US); Alwyn Dos Remedios, Vaughan (CA)

Correspondence Address: ADVANCED MICRO DEVICES, INC.;C/O VEDDER PRICE P.C., 222 N.LASALLE STREET, CHICAGO, IL, 60601, US

(73) Assignee: ATI Technologies ULC, Markham (CA)

(21) Appl. No.: 12/122,444

(22) Filed: May 16, 2008

(51) Int. Cl. H04L 9/06

(52) U.S. Cl. 380/44

(57) ABSTRACT

The various embodiments herein disclosed include a method wherein an integrated circuit (100) may receive a code image from an external device (127), encrypt the code image using a cryptographic logic (113) with a Hardware Unique Key to create a Hardware Unique Code Image (119) where the Hardware Unique Key is inaccessible to the external device (127). The integrated circuit (100) will then store the Hardware Unique Code Image wherein the Hardware Unique Code Image is executable only after decryption using the Hardware Unique Key. The method also includes sending a command to a cryptographic logic (113) to request decryption of the Hardware Unique Code Image by the cryptographic logic (113) using the Hardware Unique Key and executing the Hardware Unique Code Image by the boot software (103) after the decryption.

### FIELD OF THE DISCLOSURE

The present disclosure is related to securing software images for execution by various integrated circuit processors.

### BACKGROUND

Electronic devices such as wireless communications devices are being constantly driven to higher levels of capability based on advances in technology, consumer demand and marketing drivers such as a need for product differentiation. The processing power available today allows many of these requirements to be met using sophisticated processors such as System-on-Chip (SOC) integrated circuits that provide high levels of capability and flexibility through being programmable.

As a result, software and software development have become critical to providing capabilities, new features and functions, etc. Along with the pervasiveness of software however, there is also a need to protect the software from misappropriation, or alteration for malicious purposes. For example, software may be misappropriated or altered even at the integrated circuit level by attacks directed toward specific features and functions of the chip. At the same time, it may be necessary to gain access to software for debugging, updating or for various development needs. Also, it may be desirable to be able to provide back-ups of software in the event a primary copy becomes corrupted and unusable. However, it may be inappropriate for software copies to be easily accessible since this may lead to misappropriation of the code, etc.

For example, it may be desirable to have various code images that are specific to a given electronic device or, more specifically an integrated circuit within the electronic device, such that the code images are not usable or alterable by any other device.

### BRIEF DESCRIPTION OF THE DRAWINGS

FIG. 1 is a block diagram of an integrated circuit in accordance with an embodiment.

FIG. 2 is a block diagram illustrating a cryptographic logic coupled to a hardware unique key logic in accordance with an embodiment.

FIG. 3 is a flow chart illustrating a high level operation of an integrated circuit in accordance with an embodiment wherein a code image is received from an external device and encrypted using a hardware unique key.

FIG. 4 is a flow chart illustrating operation of an embodiment in where a command is sent to request decryption of a hardware unique code image using a hardware unique key.

FIG. 5 is a flow chart illustrates an operation of the embodiments wherein a cryptographic logic obtains a hardware unique key from a hardware unique key logic.

FIG. 6 is a flow chart for an embodiment wherein a generic code image is pushed into the integrated circuit and encrypted using an encrypted random key.

FIG. 7 is a flow chart for an embodiment for decrypting software using a random key encrypted using a hardware unique key.

FIG. 8 is a flow chart for an embodiment utilizing a flashing loader.

FIG. 9 is a flow chart illustrating detection of previously stored code where an upgrade may be needed.

FIG. 10 is a block diagram illustrating details of one embodiment having a secure communication line between a hardware unique key logic and a cryptographic logic for securely transferring a hardware unique key information there-between.

FIG. 11 is a bit map illustrating a hardware unique key information which may include a device ID, a hardware unique key and a locking bit.

FIG. 12 is a flow chart illustrating operation of the embodiment illustrated in FIG. 10.

### DETAILED DESCRIPTION

The various embodiments herein disclosed include a method wherein an integrated circuit may receive a code image from an external device, encrypt the code image using a cryptographic logic with a Hardware Unique Key to create a Hardware Unique Code Image where the Hardware Unique Key is inaccessible to the external device. The integrated circuit will then store the Hardware Unique Code Image wherein the Hardware Unique Code Image is executable only after decryption using the Hardware Unique Key.

The method also includes sending a command to request decryption of the Hardware Unique Code Image by the cryptographic logic using the Hardware Unique Key and executing the Hardware Unique Code Image by the boot software after the decryption.

The embodiments disclosed herein also provide an integrated circuit including a memory, and a cryptographic logic coupled to the memory. Where the cryptographic logic is operative to encrypt a code image using a Hardware Unique Key to create a Hardware Unique Code Image where the Hardware Unique Key is inaccessible via any port of the integrated circuit. The integrated circuit further includes the ability to store the Hardware Unique code Image in memory where the Hardware Unique Code Image is executable only after decryption using the Hardware Unique Key.

The integrated circuit herein disclosed may also include a peripheral controller, operative to control an external device to receive a code image, a memory controller, connected to the cryptographic logic, and a boot ROM, connected to the memory controller and operative to send a request for decryption of the Hardware Unique Code Image by the cryptographic logic using the Hardware Unique Key, and execute the Hardware Unique Code Image after the decryption.

An integrated circuit herein disclosed includes a peripheral controller operative to control an external device to receive a code image, a memory, a Hardware Unique Key Logic, a cryptographic logic coupled to the memory and to the Hardware Unique Key Logic and operative to send a request to the Hardware Unique Key Logic for the Hardware Unique Key, receive the Hardware Unique Key from the Hardware Unique Key Logic in response to the request, encrypt the code image using the Hardware Unique Key to create a Hardware Unique Code Image, where the Hardware Unique Key is inaccessible via any port of the integrated circuit, and store the Hardware Unique Code Image in the memory where the Hardware Unique Code Image is executable only after decryption using the Hardware Unique Key. The integrated circuit further includes a memory controller connected to the cryptographic logic and a boot ROM connected to the memory controller where in the boot ROM is operative to send a request to the cryptographic logic to request decryption of the Hardware Unique Code Image by the cryptographic logic using the Hardware Unique Key and execute the Hardware Unique Code Image after the decryption.

An integrated circuit as disclosed herein may also include a memory controller wherein the memory controller is operative to arbitrate access to memory. The integrated circuit is further operative to send a command to the cryptographic logic in response to a request by the boot ROM to cause the cryptographic logic to generate a random key, and where the cryptographic logic is further operative to generate the random key in response to the command, encrypt the random key using the Hardware Unique Key to create an encrypted random key, store the encrypted random key in a key storage memory and encrypt the code image using the encrypted random key. Alternatively, the random key may be used in an unencrypted form in some embodiments.

The integrated circuit disclosed herein may further include a peripheral controller that is operative to receive a push of a flash loader code into an internal memory of the integrated circuit and where the boot ROM is operative to verify that the flash loader code is trusted code, execute the flash loader code, and perform a challenge/response security routine with the external device, and obtain a push of the code image from the external device in response to a correct response to the challenge/response security routine.

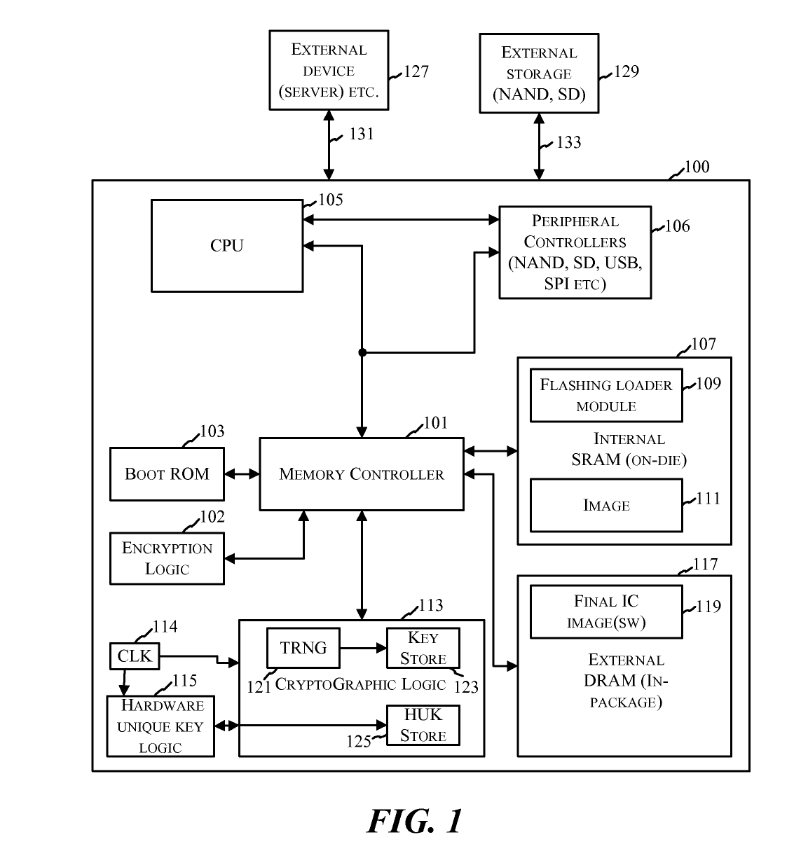

Turning now to the drawing wherein like numerals represent like components, FIG. 1 is a block diagram of an integrated circuit (IC) 100 which may be a System-on-Chip (SOC) integrated circuit in some embodiments. The integrated circuit 100 may have physical connections such as physical connection 131 and 133 which allow connection of the integrated circuit 100 to external devices such as but not limited to external device 127 and external storage 129. External device 127 may be a server, or a suitable device having a processor that may communicate with the integrated circuit 100 in order to send and receive commands. In other words, external device 127 may communicate with integrated circuit 100 using a protocol wherein the protocol may include handshaking or other negotiation procedures including security procedures such as, but not limited to, public/private key exchanges. External storage 129 may be various types of storage for example SD memory or NAND flash memory or any other suitable storage device such as, but not limited to, a USB hard drive. The external storage 129 may interact with the integrated circuit 100 via a peripheral controller 106 which interacts with the Central Processing Unit 105 and is coupled thereto. Additionally the Central Processing Unit 105 is coupled to a memory controller 101. The memory controller 101 arbitrates access to memory, such as internal RAM 107 and external RAM 117, by the CPU and other components. The memory controller 101 may also mark various areas of memory as secure memory, under the direction of the CPU.

The internal RAM 107 which may be a static RAM may be physically located on the die of the integrated circuit. The external RAM 117 which may be for example a DRAM may be physically within the package of the integrated circuit 100 but not necessarily on the same die as the memory controller. However memory may be located in any suitable position whether on the die or off the die of the integrated circuit 100. The memory controller 101 is further coupled to a boot ROM 103. The boot ROM 103 controls booting procedures of the integrated circuit 100 and may include boot ROM software and/or logic operative for the purpose of boot up of the integrated circuit 100. For example the boot ROM 103 may refer to software running from the boot ROM 103 where the boot ROM software is executed by the Central Processing Unit 105. In other embodiments, the boot ROM 103 may include software and also logic operations by logic operative to interact with the software, or independently of the software. Further, the boot ROM 103 may include secure memory wherein the secure memory is locked from access by various non-boot related logic of the integrated circuit 100.

The memory controller 101 may further be coupled to an encryption logic 102 for encrypting various information used by the integrated circuit 100 such as but not limited to software code or various encryption keys for encrypting and decrypting software such as video media software, etc. The encryption logic 102 may be for example a hashing logic for hashing a software code and providing the hash to the memory controller for storage for example internal RAM 107 or external RAM 117. The memory controller 101 is also coupled to a cryptographic logic 113. The cryptographic logic 113 is used for checking the validity of various software images to be loaded and run on the integrated circuit 100 by for example the Central Processing Unit 105. The cryptographic logic 113 may be a crypto core processor in some embodiments, an ASIC, or other appropriate logic suitable for encrypting and decrypting software code in accordance with the description provided herein. The cryptographic logic in some embodiments may further include a random number generator 121, a key storage memory 123 and a Hardware Unique Key storage 125.

The integrated circuit 100 further includes the hardware unique key logic 115 which may contain information related to the integrated circuit 100 configuration. The hardware unique key logic 115, contains fuses that once blown cannot be restored. Therefore the hardware unique key logic 115 creates a permanent set of bits which may be used for encryption of various software within the integrated circuit 100. Thus the hardware unique key logic 115 creates a Hardware Unique Key for use in encrypting images as will be described further herein.

The hardware unique key logic is coupled to the cryptographic logic 113 and shares with the cryptographic logic 113 a clocking signal from clock logic 114. A hardware unique key logic 115 bit pattern, which constitutes the Hardware Unique Key, may be serially clocked using a clock signal from clock logic 114 into the cryptographic logic 113. The cryptographic logic may then store the Hardware Unique Key in Hardware Unique Key storage memory 125. The Hardware Unique Key is specific to the integrated circuit 100 and is unlike any other Hardware Unique Key in any other integrated circuit instance. The Hardware Unique Key contained by the hardware unique key logic 115 and also within the Hardware Unique Key storage memory 125 is inaccessible through any interface of the integrated circuit 100. In other words the Hardware Unique Key may not be read out from the hardware unique key logic 115, the cryptographic logic 113 via the memory controller 101 or via any other logic within the integrated circuit 100.

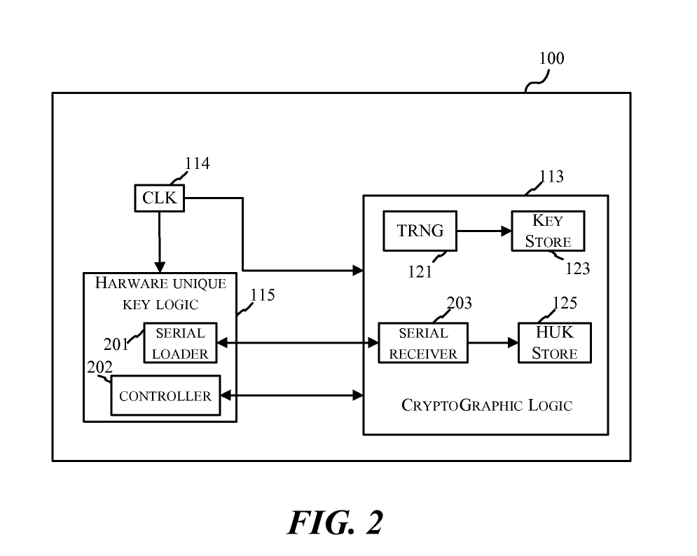

This process is illustrated in further detail in FIG. 2. As illustrated in FIG. 2 the hardware unique key logic 115 includes a serial loader 201 which is coupled to a corresponding serial receiver 203 within the cryptographic logic 113. A bit pattern representing the Hardware Unique Key from hardware unique key logic 115 is clocked via the serial loader 201 to serial receiver 203 of the cryptographic logic 113 using a clock signal generated by clock logic 114. The serial receiver 203 passes the Hardware Unique Key to a Hardware Unique Key storage memory 125 which cannot be accessed by logic external to the cryptographic logic 113.

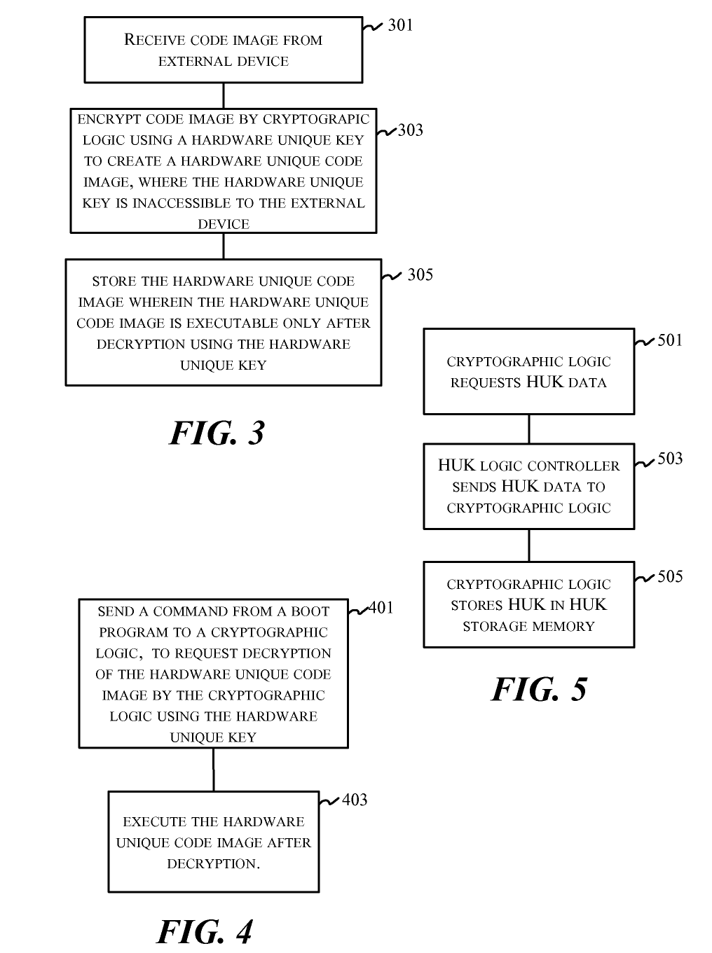

In accordance with the various embodiments the Hardware Unique Key stored within the cryptographic logic 113 may be used to encrypt software loaded into the integrated circuit 100 such that the software encrypted using the Hardware Unique Key is unique to the integrated circuit 100 and cannot be used by any other integrated circuit or device. An exemplary method of the various embodiments is illustrated in FIG. 3. In 301 the integrated circuit receives a code image from an external device. The external device may be a server such as server 127 or an external storage such as a NAND flash memory or SD memory such as external storage 129. In 303 the code image is encrypted by the cryptographic logic 113 using the Hardware Unique Key to create a Hardware Unique Code Image, where the Hardware Unique Key is inaccessible to the external device 127. Likewise the encrypted code image is unusable by any external device or external integrated circuit. In 305 the Hardware Unique Code Image may be stored within the integrated circuit 100 where the Hardware Unique Code Image is executable only after a decryption operation using the Hardware Unique Key to decrypt the code image. For example, in FIG. 1, the external device 127 may provide a code image 111 which may be obtained via the peripheral controllers 106 and stored in internal RAM 107 as image 111. The CPU 105 may request that the cryptographic logic 113 use the Hardware Unique Key stored in Hardware Unique Key storage memory 125 to encrypt the image 111. After encryption of the image 111, the encrypted image may be stored as final integrated circuit image 119 in, for example, the external RAM 117 as shown in FIG. 1. The final integrated circuit image 119 is then unusable by any device external to integrated circuit 100.

FIG. 4 illustrates a method of the various embodiments wherein the final integrated circuit image 119 may be run by the Central Processing Unit 105. For example, in 401, the boot ROM 103 may send a command to the cryptographic logic 113 to request decryption of the Hardware Unique Code Image final integrated circuit image 119 using the Hardware Unique Key. The cryptographic logic 113 may then obtain the final integrated circuit image 119 from external RAM 117 and decrypt it using the Hardware Unique Key stored in the Hardware Unique Key storage memory 125. As shown in 403, the boot ROM 103 may then execute the Hardware Unique Code Image after decryption.

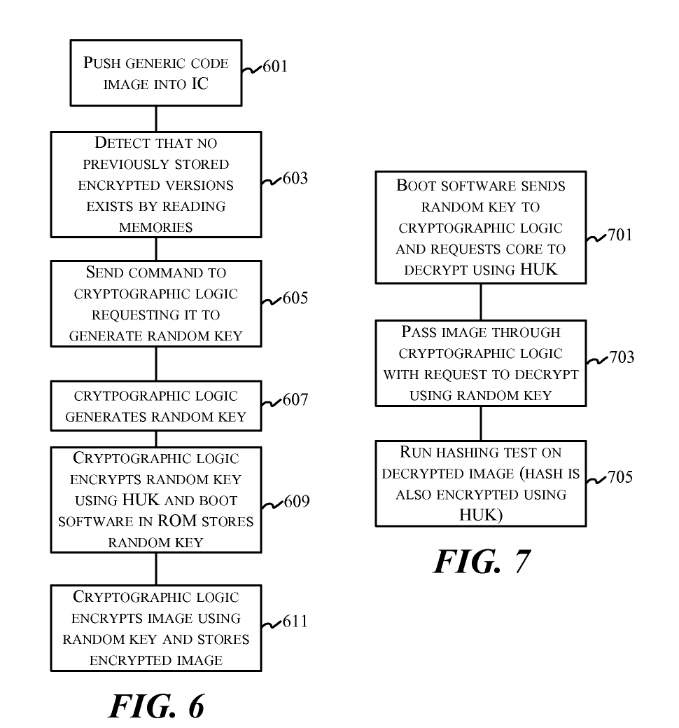

FIG. 5 illustrates the method as described previously with respect to FIG. 2. The cryptographic logic 113 as shown in 501 may request Hardware Unique Key data from the hardware unique key logic 115 and, in 503, the hardware unique key logic 115, via a controller 202 as shown in FIG. 2, instructs the serial loader 201 to send the Hardware Unique Key bit pattern to the cryptographic logic serial receiver 203. As shown in 505, the cryptographic logic 113 stores the Hardware Unique Key in the Hardware Unique Key storage memory 125. FIG. 6 illustrates details of the various embodiments wherein a generic code image may be pushed into the integrated circuit 100 as shown in 601. Although not shown in FIG. 6, the boot ROM 103 software may verify that any generic code pushed into the integrated circuit 100 is valid code. For example, the integrated circuit 100 may perform a challenge/response or some other appropriate security mechanism between the external device 127 and the integrated circuit 100, to verify that the external device 127 is an authorized provider of software to the integrated circuit 100. Therefore, in accordance with the embodiments, the generic code image pushed into the IC, as illustrated in 601, will be validated by the integrated circuit 100 before any further operation is performed regarding the code image. In 603, the integrated circuit 100 will detect that no previously stored encrypted versions of the generic code image exists in the memory, such as internal RAM 107 or external RAM 117, by reading various memory locations. This operation may be performed by, for example, the boot ROM 103.

Assuming that no previously stored versions were located in 603, the boot ROM 103 may send a command to the cryptographic 113 requesting the cryptographic to generate a random key. As shown in 607, the cryptographic logic 113 may use a random number generator 121, which in some embodiments may be a true random number generator, to generate the random key as requested. As shown in 609, the cryptographic logic 113 may proceed to encrypt the random key using the Hardware Unique Key stored in Hardware Unique Key storage 125, after which the boot ROM 103 may store the encrypted random key in an appropriate location in memory. As shown in 611 the cryptographic logic may then encrypt the code image such as code image 111 using the encrypted random key and proceed to store the encrypted code image as final integrated circuit image 119 for example.

To execute the final integrated circuit image code 119, the boot ROM software 103 will send the random key, in an encrypted form, to the cryptographic logic 113 and request that the cryptographic logic 113 decrypt the final integrated circuit image 119 using the random key. The random key must be decrypted using the hardware unique key in some embodiments. As shown in 703, the final integrated circuit image 119 will be passed through the cryptographic logic with the request from the boot ROM 103 to decrypt it using the random key as shown in 703. In 705 the cryptographic logic may run an additional hashing test on the decrypted image wherein the hash in also encrypted using the Hardware Unique Key.

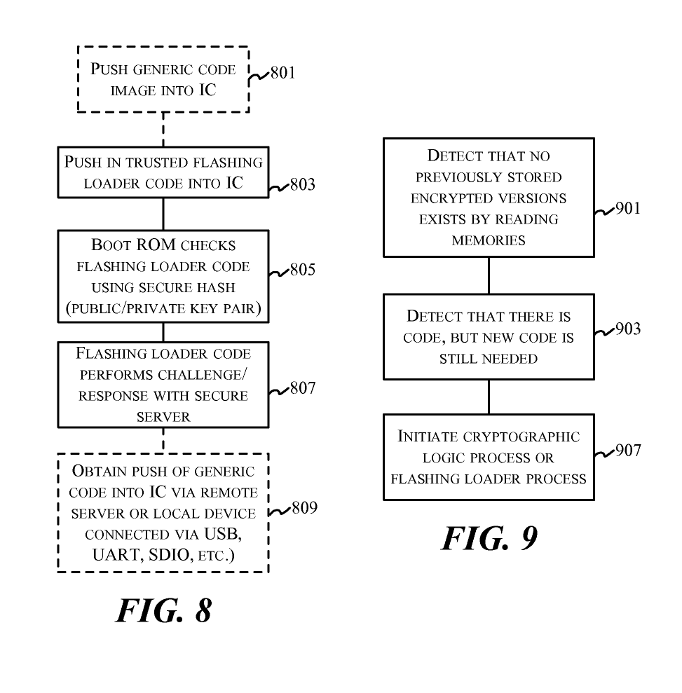

FIG. 8 illustrates another embodiment wherein the integrated circuit 100 may be initially flashed by receiving a push of a trusted flash loader code. A generic code image may be pushed into the integrated circuit initially as shown in 801 or may alternatively be pushed into the integrated circuit via the remote server 127 or a local device such as external storage 129 as shown in 809. For either of the two embodiments, a push of a trusted flash loader code into the integrated circuit 100 will occur as illustrated in 803. The boot ROM 103 will check the flash loader code using, for example, a secure hash. This may involve using, for example, a public/private key pair or any other appropriate security mechanism as would be understood by one of ordinary skill. In 807, the flash loader code, such as the flash loading module 109 illustrated in FIG. 1, may perform a challenge/response with an external device, such as an external server 127, to obtain the push of the generic code as shown in 809. In accordance with the various embodiments, the generic code may be encrypted using the Hardware Unique Key as was described previously.

FIG. 9 illustrates operation of integrated circuit 100 for various situations in which a generic code image is provided to the integrated circuit. For example, upon a push of a generic code image into the integrated circuit, the boot ROM 103 may check to detect that no previously stored encrypted versions exist by reading various memory locations as shown in 901. As shown in 903, the boot ROM may detect that code does exist, but new code is still needed, for example, when an older version exists in memory but a newer version has been pushed into the device for purposes of performing an upgrade. In 907, the boot ROM 103 may initiate the cryptographic process described earlier, or the flash loader process described with respect to FIG. 8.

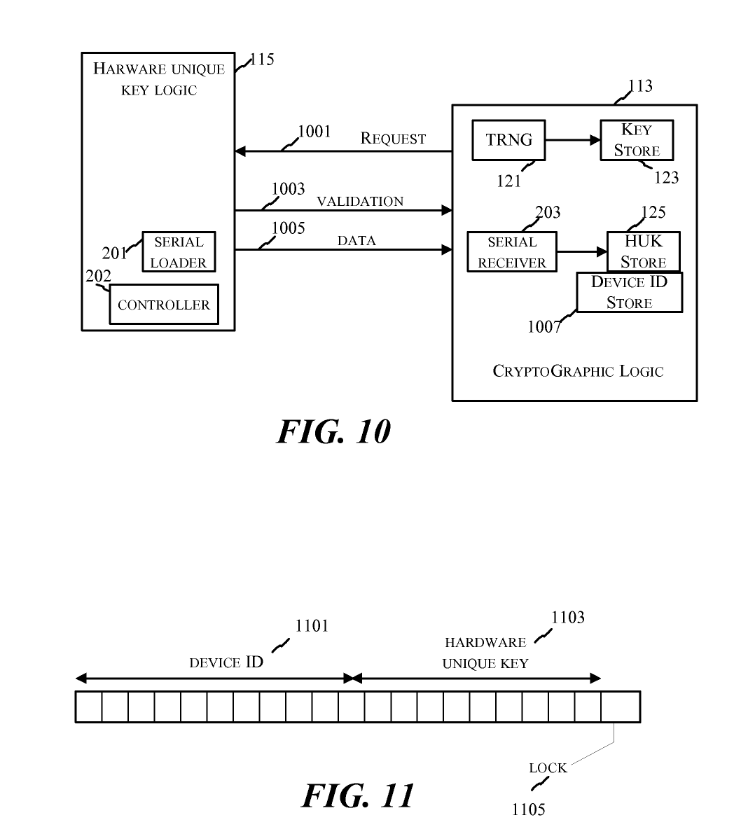

FIG. 10 illustrates an embodiment for securely transferring a hardware unique key information from a hardware unique key logic 115 to a cryptographic logic 113. In accordance with the illustrated embodiment, the hardware unique key logic 115, and the cryptographic logic 113 have a secure communication line consisting of a request line 1001, a validation line 1003 and a data line 1005. The secure communication line is isolated from any scan chains of the integrated circuit, and from any test mechanism such that no mechanism can access the hardware unique key information other than the cryptographic logic 113. The hardware unique key logic 115 is initially programmed with a hardware unique key, and a device ID in some embodiments, in a secure environment such as, for example, at the time of manufacture of the integrated circuit.

FIG. 11 is a bit map illustrating an exemplary hardware unique key information. For example, in some embodiments the hardware unique key information may include a device ID 1101 and a hardware unique key 1103. The hardware unique key information may further include lock 1105 which may be a single bit in some embodiments. As an example, the device ID 110 may be 128 bits in length, the hardware unique key may be 128 bits in length, and the lock may be a single bit. The cryptographic logic 113 may therefore include a device ID store 1007 for storing the device ID 1101.

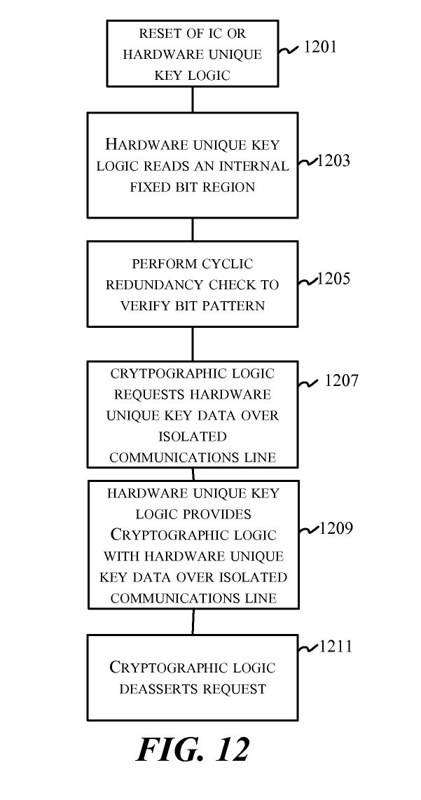

FIG. 12 illustrates operation of the embodiment illustrated in FIG. 10. In 1201, a reset of the integrated circuit or the hardware unique key logic 115 may occur. In 1203, the hardware unique key logic 115 reads a secure internal fixed bit region corresponding to the secure environment programming as discussed above. In 1205, the hardware unique key logic 115 may perform a cyclic redundancy check (CRC) on the bit pattern to ensure its validity. The cryptographic logic 113 may request the hardware unique key information over the secure data request line 1001 as shown in 1207. The hardware unique key logic may then confirm the validity of the hardware unique key information over the validation line 1003, and provide the cryptographic logic 113 with the hardware unique key information over data line 1005, as shown in 1209. As shown in FIG. 11, the lock bit 1105 will be transferred to the cryptographic logic 113 as the first bit on the serial line followed by the hardware unique key 1103, which may be for example 128 bits, and then the device ID 1101, which may likewise be 128 bits, the serial transfer being from least significant bit to most significant bit in some embodiments. The lock bit serves as a flag to the cryptographic logic 113 such that a counter is not required. The cryptographic logic 113 may then de-assert the request on request line 1001 as shown in 1211. The transfer of the hardware unique key information over data line 1005 may be

The above detailed description and the examples described therein have been presented for the purposes of illustration and description only and not for limitation. For example, the operations described may be done in any suitable manner. The method steps may be done in any suitable order still providing the described operation and results. It is therefore contemplated that the present embodiments cover any and all modifications, variations or equivalents that fall within the spirit and scope of the basic underlying principles disclosed above and claimed herein.

What is claimed is:

1. A method comprising:
encrypting a code image, from an external device, by a cryptographic logic using a hardware unique key to create a hardware unique code image, said hardware unique key being inaccessible to said external device; and
storing said hardware unique code image wherein said hardware unique code image is executable only after decrypting said hardware unique code image using said hardware unique key.

2. The method of claim 1, comprising:
sending a command to said cryptographic logic, said command requesting decryption of said hardware unique code image by said cryptographic logic using said hardware unique key;
decrypting said hardware unique code image; and
executing said hardware unique code image by said boot software after said decryption.

3. The method of claim 1, wherein encrypting said code image by a cryptographic logic using a hardware unique key to create a hardware unique code image, said hardware unique key being inaccessible to said external device, further comprises:
sending a command to said cryptographic logic to request that said cryptographic logic generate a random key;
generating a random key by said cryptographic logic;
encrypting said random key by said cryptographic logic using said hardware unique key;
storing said encrypted random key in a memory; and
encrypting said code image by said cryptographic logic using said encrypted random key.

4. The method of claim 1, after receiving a code image from an external device, comprising:
determining that no previous encrypted version of said code image is present in memory.

5. The method of claim 1, after receiving a code image from an external device, comprising:
determining that a previous encrypted version of said code image is present in memory and that a code update is required.

6. The method of claim 5, after determining that a previous encrypted version of said code image is present in memory and that a code update is required, comprising:
pushing a flashing loader code into a memory;
verifying, by a boot software, that said flashing loader code is trusted;
executing said flashing loader code;
performing a challenge/response security routine with an external device; and
obtain push of code image from said external device.

7. The method of claim 1, prior to encrypting said code image by a cryptographic logic using a hardware unique key, comprising:
requesting a hardware unique key from a hardware unique key serial loader; and
receiving from said serial loader by a serial receiver, a set of serial bits corresponding to said hardware unique key.

8. An integrated circuit comprising:
a memory; and
a cryptographic logic coupled to said memory, said cryptographic logic operative to:
encrypt a code image using a hardware unique key to create a hardware unique code image, said hardware unique key being inaccessible via any port of said integrated circuit; and
store said hardware unique code image in said memory wherein said hardware unique code image is executable only after decrypting said hardware unique code image using said hardware unique key.

9. The integrated circuit of claim 8, comprising:
a peripheral controller, operative to control an external device to receive said code image therefrom;
a memory controller, coupled to said cryptographic logic; and
a boot ROM, coupled to said memory controller; said boot ROM operative to:
send a request to said cryptographic logic to request decryption of said hardware unique code image by said cryptographic logic using said hardware unique key; and
execute said hardware unique code image after said decryption.

10. The integrated circuit of claim 8, comprising:
a CPU operatively coupled to said memory and said cryptographic logic, wherein said memory controller is operative to:
send a command to said cryptographic logic, in response to said request by said memory controller, to cause said cryptographic logic to generate a random key; and
wherein said cryptographic logic is further operative to:
generate said random key in response to said command; and
encrypt said random key using said hardware unique key to create an encrypted random key;
store said encrypted random key in a key storage memory; and
encrypt said code image using said encrypted random key.

11. The integrated circuit of claim 9, wherein said boot ROM is further operative to:
after receiving said code image from said external device, determine that no previous encrypted version of said code image is present in an internal memory of said integrated circuit.

12. The integrated circuit of claim 9, wherein said boot ROM is further operative to:
after receiving said code image from said external device, determine that a previous encrypted version of said code image is present in an internal memory of said integrated circuit; and
determine that a code update of said code image is required.

13. The integrated circuit of claim 12, wherein said peripheral controller is further operative to:
receive a push of a flashing loader code into said internal memory of said integrated circuit; and wherein said boot ROM is further operative to:
verify that said flashing loader code is trusted; and
execute said flashing loader code, wherein said flashing loader code is operative to:
perform a challenge/response security routine with said external device; and
obtain a push of said code image from said external device in response to a correct response to said challenge/response security routine.

14. The integrated circuit of claim 8, comprising:
a hardware unique key logic, operatively coupled to said cryptographic logic, said hardware unique key logic operative to:
receive a request from said cryptographic logic for said hardware unique key; and
send said hardware unique key to said cryptographic logic in response to said request.

15. The integrated circuit of claim 14, wherein said hardware unique key logic further comprises:
a serial loader; and
wherein said cryptographic logic further comprises:
a serial receiver operatively coupled to said serial loader of said hardware unique key logic, said serial receiver operative to receive a set of serial bits from said serial loader, said set of serial bits corresponding to said hardware unique key.

16. The integrated circuit of claim 15, wherein said hardware unique key logic is initially configurable to a predetermined bit pattern, said bit pattern for producing said set of serial bits corresponding to said hardware unique key, said hardware unique key logic being permanently configured to said predetermined bit pattern after an initial configuration.

17. The integrated circuit of claim 10, wherein said cryptographic logic further comprises:
a random number generator logic, operative to generate said random key.

18. An integrated circuit comprising:
a peripheral controller, operative to control an external device to receive said code image therefrom;
a memory;
a hardware unique key logic;
a cryptographic logic operatively coupled to said memory and to said hardware unique key logic, said cryptographic logic operative to:
send a request to said hardware unique key logic for said hardware unique key;
receive said hardware unique key from said hardware unique key logic in response to said request;
encrypt said code image using said hardware unique key to create a hardware unique code image, said hardware unique key being inaccessible via any port of said integrated circuit; and
store said hardware unique code image in said memory wherein said hardware unique code image is executable only after decrypting said hardware unique code image using said hardware unique key;
a memory controller, operatively coupled to said cryptographic logic; and
a boot ROM, operatively coupled to said memory controller; said boot ROM operative to:
send a request to said cryptographic logic to request decryption of said hardware unique code image by said cryptographic logic using said hardware unique key; and
execute said hardware unique code image after said decryption.

19. The integrated circuit of claim 18, comprising:
a CPU, operatively coupled to said peripheral controller, said memory, said hardware unique key logic, said cryptographic logic, said memory controller and said boot ROM, wherein said CPU is operative to:
send a command to said cryptographic logic, in response to said request by said boot ROM, to cause said cryptographic logic to generate a random key; and
wherein said cryptographic logic is further operative to:
generate said random key in response to said command;
encrypt said random key using said hardware unique key to create an encrypted random key;
store said encrypted random key in a key storage memory; and
encrypt said code image using said encrypted random key.

20. The integrated circuit of claim 19, wherein said peripheral controller is further operative to:
receive a push of a flashing loader code into said internal memory of said integrated circuit; and wherein said boot ROM is further operative to:
verify that said flashing loader code is trusted;
execute said flashing loader code;
perform a challenge/response security routine with said external device; and
obtain a push of said code image from said external device in response to a correct response to said challenge/response security routine.
